(19) United States
(12) Patent Application Publication
(10) Pub. No.: US 2024/0204251 A1
(43) Pub. Date: Jun. 20, 2024

(54) ELECTROLYTE ADDITIVES FOR IMPROVING ELECTROCHEMICAL CELL PERFORMANCE

(71) Applicant: Ramot at Tel-Aviv University Ltd., Tel-Aviv (IL)

(72) Inventors: Emanuel PELED, Tel Aviv (IL); Tzach MUKRA, Tel Aviv (IL); Evelina FAKTOROVICH SIMON, Tel Aviv (IL); Roy MARRACHE, Tel Aviv (IL); Tamir ASSA, Tel Aviv (IL); Niv ALONI, Tel Aviv (IL)

(73) Assignee: Ramot at Tel-Aviv University Ltd., Tel-Aviv (IL)

(21) Appl. No.: 18/288,837

(22) PCT Filed: Apr. 15, 2022
(86) PCT No.: PCT/IL2022/050400

§ 371 Date: Oct. 30, 2023

Related U.S. Application Data
(60) Provisional application No. 63/184,336, filed on May 5, 2021.

(51) Int. Cl. H01M 10/0567; H01M 4/02; H01M 4/38; H01M 10/0525; H01M 10/0562; H01M 10/0568; H01M 10/0569

(52) U.S. Cl. CPC H01M 10/0567; H01M 4/381; H01M 10/0525; H01M 10/0562; H01M 10/0568; H01M 10/0569; H01M 2004/027; H01M 2004/028; H01M 2300/0028; H01M 2300/0065

(57) ABSTRACT

An electrochemical cell is described herein, which comprises an anode, cathode and liquid electrolyte, as well as a rechargeable alkali metal ion battery comprising at least one such electrochemical cell. The anode comprises an alkali metal and/or a conductive solid suitable for deposition of the alkali metal thereupon; the cathode comprises a substance capable of reversibly absorbing and releasing ions of the alkali metal; and the liquid electrolyte comprises at least one additive selected from the group consisting of a nanoparticle dispersed in the liquid electrolyte and a polymer dissolved and/or dispersed in the liquid electrolyte. Further described herein is a process for preparing the electrochemical cell by contacting the liquid electrolyte with the cathode and/or said conductive solid, wherein the conductive solid is substantially devoid of the alkali metal, or the conductive solid is coated with a layer of the alkali metal.

### RELATED APPLICATIONS

This application claims the benefit of priority of U.S. Provisional Patent Application No. 63/184,336 filed on 5 May 2021, the contents of which are incorporated herein by reference in their entirety.

### FIELD AND BACKGROUND OF THE INVENTION

The present invention, in some embodiments thereof, relates to electrochemistry, and more particularly, but not exclusively, to electrolyte compositions which can be used in an alkali metal battery.

Further development of portable electronic devices and electric vehicles would be facilitated by improvement or replacement of the common lithium ion (Li-ion) battery system. A typical Li-ion battery is composed of a cathode such as lithium nickel manganese cobalt oxide (NMC), lithium nickel cobalt aluminum oxide (NCA), or lithium iron phosphate (LFP) cathode, a separator, and graphite anode (as well as current collectors for each electrode, and other inert battery packaging materials). Replacing the graphite anode with lithium metal is currently a promising approach to enhancing the cycling performance of the battery [Liu et al., Nat Energy 2019. 4:180-186; Liu et al., Joule 2018, 2:833-845; Zheng et al., Nat Energy 2017, 2:17012; Ren et al., Joule 2019, 3:1662-1676]. Lithium is a very light metal (0.534 g/cm³) with high specific capacity (3862 mAh/g, ten times that of graphite) and has the most negative standard electrochemical potential (3.04 V vs. a standard hydrogen electrode), showing its electrochemical superiority to the graphite anode.

In lithium metal battery (LMB) systems, lithium is deposited during the charge process, and dissolved during discharge. A major disadvantage with the construction of the lithiated-cathode/Li cell is the use of excess lithium. Such excess can dramatically lower the practical energy density of the cell [Albertus et al., Nat Energy 2018, 3:16-21].

Omission of the anode in the cell build-up, leaving just the copper current collector in the anodic side, results in an “anode-free lithium metal battery” (AFLMB) [Xie et al., Energy Storage Mater 2020, 32:386-401; Nanda et al., Adv Energy Mater 2021, 22:1-18]. In this type of battery, only the amount of lithium ions originating in the cathode will participate in the deposition/dissolution of lithium that occurs on the copper at the anode side. The lack of anode volume and weight increases the volumetric energy density and specific energy of the battery by a significant amount. For example, after full plating of lithium in an AFLMB, on the assumption of an exaggerated (˜20%) volume expansion due to the plating, the volumetric energy density is greater by 57%, as compared to that of a standard Li-ion battery [Nanda et al., Adv Energy Mater 2021, 22:1-18]. Omitting the anode also reduces the cost of battery production, in terms of active material cost and electrode preparation and assembly processes [Schmuch et al., Nat Energy 2018, 3:267-278].

Although the AFLMB exhibits potential for a high-performance battery system, it still faces several hurdles that must be overcome in order to reach the consumer demand for a high-energy and stable-energy storage device. One factors to be addressed is the solid-electrolyte interphase (SEI), a layer which covers the anode and acts as an interphase between the lithium metal and the electrolyte solution, and is a key factor regarding the safety, coulombic efficiency, power capability, morphology of lithium deposits, shelf life and cycle life of the battery. Several undesired processes take place during the cycling of LMB (AFLMB included), which are affected by the properties of the lithium deposition/dissolution process that occur on the copper current collector. Examples of such processes are reduction of the electrolyte components, capacity consumed at the repair of the SEI, formation of dead lithium (which depends on the current density) and dendrite formation. One of the major reasons for the progression of such processes is uneven deposition of lithium on the copper, which may result, for example, from a non-smooth copper surface and concentration gradients [Sahalic et al., J Power Sources 2019, 437:226912]. Uneven deposition, on the one hand, may apply stresses on the SEI during cycling and cause mechanical damage, while on the other hand, it initiates the formation and growth of dendrites. Dendrite initiation and growth result from two processes. At the peak of the dendrites a fresh SEI is formed. This freshly formed SEI has a higher concentration of defects, thus higher lithium-ion conductivity. This causes preferential lithium deposition in these areas which leads to the continuous growth of the dendrites. Another mechanism is the preferential lithium-ion conduction at the grain boundaries (GB) of the SEI nanoparticles, at which the concentration of lithium-ion defects is higher than that in the bulk of the crystals [Peled, J Electrochem Soc 1979, 126:2047-2051]. Different approaches have been investigated in order to address the issues mentioned above in LMB and AFLMB specifically. These include engineering of artificial SEI on the copper via surface modification by PEO, modification via tin-plated copper and graphene-oxide coating [Assegie et al., Nanoscale 2018, 10:6125-6138; Zhang et al., Electrochim Acta 2017, 1201-1207; Wondimkun et al., J Power Sources 2020, 450:227589]. The use of highly concentrated electrolytes was studied, either with LiFSI or with LiPF₆ [Qian et al., Adv Funct Mater 2016, 26:7094-7102; Hagos et al., ACS Appl Mater Interfaces 2019, 11:9955-9963]. The external pressure on pouch cells and the effect of temperature have also been investigated [Genovese et al., J Electrochem Soc 2019, 166:A3342-A3347; Louli et al., J Electrochem Soc 2019, 166:A1291-A1299].

Another approach that has been studied is the use of a variety of nanoparticles, which have been reported to enhance cycling performance for several reasons.

Tan et al. [J Power Sources 2020, 463:228257] reported improved cycling performance in LFP/Li cells as a result of TiO₂ coating on lithium-metal anodes. This study was conducted on the basis that lithiophilic substances (such as TiO₂) can serve as lithium-nucleation sites and thus achieve a uniform lithium deposit and suppress dendrite formation.

Xu et al. [J Power Sources 2018, 391:113-119] reported that silane-Al₂O₃(Al₂O₃—ST) nanoparticles incorporated into a liquid electrolyte help to increase the lithium-ion transference number and to enhance battery safety; and that the cycling stability and rate capacity of LiNi_{0.5}Mn_{1.5}O₄/Li batteries were improved by the use of the hybrid electrolyte.

Lee et al. [ACS Appl Mater Interfaces 2020, 12:37188-37196] reported that SiO₂ nanoparticle-dispersed colloidal electrolyte (NDCE) suppresses the formation of lithium dendrites; and that SiO₂ nanoclusters in the NDCE play roles in enhancing lithium-ion transference number and increasing its diffusivity in the vicinity of the lithium-plating substrate.

Gel-polymer electrolyte (GPE) serves as another approach for improving LMB performance. Polymers have been used for the gelation of liquid electrolytes (generation of GPE), to preserve their high ionic conductivity and to prevent leakage from the electrochemical cell. In general, the generation of GPEs involves the formation of a polymer host skeleton, and filling it afterwards with a liquid electrolyte. The polymer host skeleton usually provides GPEs with mechanical strength, whereas the liquid electrolyte is responsible for its high ionic conductivity. Due to the presence of the liquid electrolyte, conductivity and transport properties of GPEs are similar to those of some liquid organic electrolytes at room temperature. The influence of polymer hosts such as PMMA, PEO, PVDF, PVDF-HFP, PAN and PVP on its conductivity and mechanical properties was previously studied [Li et al., RSC Adv 2017, 7:23494-23501; Li et al., RSC Adv 2016, 6:97338-97345; Vondrak et al., Electrochim Acta 2001, 46:2047-2048; Zhu et al., Adv Energy Mater 2014, 4:1300647; Kim et al., Materials (Basel) 2018, 11:543; Wang et al., ACS Appl Mater Interfaces 2014, 6:19360-19370; Liu et al., J Solid State Electrochem 2018, 22:807-816].

Kuo et al. [ACS Appl Mater Interfaces 2014, 6:3156-3162] describe a polyacrylonitrile (PAN)-interpenetrating crosslinked polyoxyethylene (PEO) network for the construction of GPE. This membrane was soaked in a solution of 1.0M LiPF₆ in ethylene carbonate (EC)/dimethyl carbonate (DMC)/diethyl carbonate (DEC) (1:1:1 w/w), and the obtained GPE was reported to have higher ionic conductivity than commercial Celgard® M824 separator filled with the same electrolyte.

Huang et al. [J Electroanal Chem 2017, 804: 133-139] describe a GPE prepared by soaking a synthesized poly(propylene carbonate) (PPC)/poly(methyl methacrylate) (PMMA)-coated Celgard® polyethylene (PE) membrane in a solution of 1.0M LiPF₆ in EC/DMC (1:1 v/v). The coating was based on PMMA because of its high affinity for electrolytes, which it possesses thanks to the presence of ester groups in it. A Li/LiFePO₄ cell with this GPE was reported to exhibit high ionic conductivity at room temperature, and better cycle life than a pristine PE separator with the same electrolyte.

Kufian et al. [Solid State Ionics 2012, 208:36-42] describe the performance of GPEs based on EC:PC (1:1 w/w) with different amounts of LiBOB and PMMA (10 to 50 w/w); and report that the conductivity of liquid electrolyte decreases with the addition of PMMA.

The abovementioned studies relate to an immobilized form of liquid electrolyte in a polymeric matrix.

Li et al. [ACS Appl Energy Mater 2018, 1:2664-2670] reported that addition of ionic liquid-decorated PMMA nanoparticles to LiTFSI/PC-MA electrolyte, at low temperatures, was associated with improved performance of LTO/Li cells in the presence of the PMMA nanoparticles. This improvement was ascribed to the formation of a stable SEI with high ionic conductivity, which facilitates Li-ion transport, and increases the rate of the electrochemical reaction.

### SUMMARY OF THE INVENTION

Because of their higher energy density, rechargeable lithium metal batteries (LMB) have been considered as an alternative to conventional lithium ion batteries, e.g., with a graphite anode. The use of anode-free lithium metal batteries (AFLMB) may improve LMB performance, for example, by increasing the specific energy of the battery.

The present inventors have uncovered that addition of nanoscale ceramics and polymers in electrolytes can improve the cycling performance of the cell and the properties of the anodic solid-electrolyte interphase (SEI).

While reducing the present invention to practice, the inventors tested anode-free NCA/Cu cells containing additives in the form of small amounts (e.g., 0.5% to 5%) of ceramic nanoparticles such as Al₂O₃, TiO₂ and SiO₂ nanoparticles in carbonate-based electrolytes, or dissolved, or by dissolving small amounts (0.1% to 15%, mostly from 0.1% to 5%) of polymers such as PMMA, PVDF, PAN, PEO and PVP in such electrolytes. The nanoparticles resulted in improved cell-cycling performance, with the best results (with 1% TiO₂) involving a coulombic efficiency (CE) of 99.39% and capacity retention (CR) of at least 70% over 36 cycles (three-fold the number of cycles for which the reference cell CR was at least 70%). Furthermore, enhancement of performance was shown to occur in different types of lithium salt-containing electrolytes. Similarly, polymers enhanced performance, with the best results (with 1% PMMA) involving a CE of 99.02% (and CR of at least 70%) over 28 cycles.

According to an aspect of some embodiments of the present invention, there is provided an electrochemical cell that includes:
an anode that includes an alkali metal and/or a conductive solid suitable for deposition of the alkali metal thereupon;
a cathode that includes a substance capable of reversibly absorbing and releasing ions of the alkali metal; and
a liquid electrolyte that includes at least one additive selected from the group consisting of a nanoparticle dispersed in the liquid electrolyte and a polymer dissolved and/or dispersed in the liquid electrolyte.

In some embodiments, the concentration of the nanoparticles in the liquid electrolyte is in a range of from 0.5 to 10 weight percent.

In some embodiments, the nanoparticles comprise a compound characterized by being compatible with non-aqueous solution and with the cathode, and selected from the group consisting of Al₂O₃, TiO₂, SiO₂, CeO₂, ZrO₂, Ag₂O, AgO, CuO, NiO, ZnO, ZnCO₃, SiC, SnO₂, In₂O₃, Fe₂O₃ and Ga₂O₃.

In some embodiments, the nanoparticles comprise a metal fluoride solid characterized by being compatible with non-aqueous solution and with the cathode, and wherein the metal in the metal fluoride solid is selected from the group consisting of Li, Na, K, Rb, Be, Mg. Ca, Sr, Ba, Ti, Zr, V, Cr, Mo, W, Mn, Fe, Co, Ni, Cu, Ag, Zn, Cd, Al, Ga, In, Tl, Si, Ge, As, Sb, and Bi.

In some embodiments, the nanoparticles comprise a compound characterized by being compatible with a non-aqueous solution and with the cathode, the compound is selected from the group consisting of a metal oxide, a metal carbide, a metal phosphide, a metal nitride, a metal sulfide, and the metal in the metal oxide, the metal carbide, the metal phosphide, the metal nitride, and the metal sulfide is individually selected from the group consisting of Be, Ca, Sr, Ba, Ti, Zr, V, Cr, Mo, W, Mn, Fe, Co, Ni, Cu, Ag, Zn, Cd, Al, Ga, In, Tl, Ge, As, Sb, Bi and Si.

In some embodiments, the concentration of the polymer in the liquid electrolyte is in a range of from 0.1 to 20 weight percent.

In some embodiments, the polymer is selected from the group consisting of polyacrylonitrile, polyvinyl pyrrolidone, polymethyl methacrylate, polyvinylidene difluoride, and polyethylene oxide.

In some embodiments, the polyethylene oxide is selected from the group consisting of polyethylene oxide having a molecular weight in a range of from 3 kDa to 6 MDa, polyethylene oxide dimethyl ether having a molecular weight in a range of from 250 Da to 2 kDa, and polyethylene oxide monomethyl ether having a molecular weight in a range of from 350 Da to 5 kDa.

In some embodiments, the electrochemical cell further includes a solid electrolyte and/or separator.

In some embodiments, the liquid electrolyte is in a form of a thin film positioned between the solid electrolyte and the anode and/or between the solid electrolyte and the cathode.

In some embodiments, the liquid electrolyte is in a form of a thin film positioned between the solid electrolyte and the anode and a concentration of the nanoparticles in the liquid electrolyte is in a range of from 0.1 to 5 weight percent.

In some embodiments, the thin film is characterized by an average thickness in a range of from 10 nm to 10 μm.

In some embodiments, the average thickness is in a range of from 100 nm to 5 μm.

In some embodiments, the liquid electrolyte includes at least one organic solvent (a non-aqueous solvent).

In some embodiments, the anode is made of silicon, silicon alloy, carbon, graphite, nickel, copper, and stainless foil.

In some embodiments, the organic solvent (the non-aqueous solvent) is selected from the group consisting of a carbonate ester and an ether.

In some embodiments, the carbonate ester is selected from the group consisting of dimethyl carbonate, ethyl methyl carbonate, diethyl carbonate, ethylene carbonate, fluoroethylene carbonate, vinylene carbonate and propylene carbonate.

In some embodiments, the ether is selected from the group consisting of dimethyl ether, 1,3-dioxolane, triethylene glycol dimethyl ether, and polyethylene glycol, wherein the polyethylene glycol is optionally terminated by a hydrocarbon.

In some embodiments, the liquid electrolyte includes at least one alkali metal salt.

In some embodiments, the alkali metal salt includes a counter-ion selected from the group consisting of hexafluorophosphate, trifluoromethanesulfonate, bis(trifluoromethane)sulfonimide, tetrafluoroborate, bis(oxalato)borate, and difluoro(oxalato)borate.

In some embodiments, the substance capable of reversibly absorbing and releasing ions of the alkali metal is selected from the group consisting of sulfur, FePO₄, MnO₂, CoO₂. NiₓCo_{y}Al_{1-x-y}O₂, NiₓCo_{y}Mn_{1-x-y}O₂, and alkalated forms thereof, wherein x and y are independently in a range of from 0 to 1, provided that the sum of x and y is no more than 1.

In some embodiments, the pressure within the cell is in a range of from 1 to 20 atmospheres.

In some embodiments, the pressure is in a range of from 2 to 5 atmospheres.

In some embodiments, the alkali metal is selected from the group consisting of lithium, sodium and potassium.

In some embodiments, the alkali metal is lithium.

According to another aspect of some embodiments of the present invention, there is provided a process for preparing the electrochemical cell provided herein, the process includes contacting the liquid electrolyte with the cathode and/or the conductive solid, wherein the conductive solid is substantially devoid of the alkali metal, to thereby obtain the electrochemical cell in a discharged state wherein the cathode is in an alkalated form.

In some embodiments, the process further includes contacting the liquid electrolyte with a solid electrolyte.

In some embodiments, the process further includes applying an electric potential between the conductive solid and the cathode such that the alkali metal deposits on the conductive solid, to thereby obtain the electrochemical cell in a charged state.

According to yet another aspect of some embodiments of the present invention, there is provided a process of preparing the electrochemical cell provided herein, the process includes contacting the liquid electrolyte with the cathode and/or the conductive solid, wherein the conductive solid is coated with a layer of the alkali metal.

In some embodiments, the process further includes contacting the liquid electrolyte with a solid electrolyte.

In some embodiments, the average thickness of the layer of the alkali metal is in a range of from 0.1 to 20 μm.

According to still another aspect of some embodiments of the present invention, there is provided a rechargeable alkali metal ion battery that includes at least one electrochemical cell as provided herein.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents a schematic comparison of a cell of a lithium metal battery (LMB) and a cell of an anode-free lithium metal battery (AFLMB);

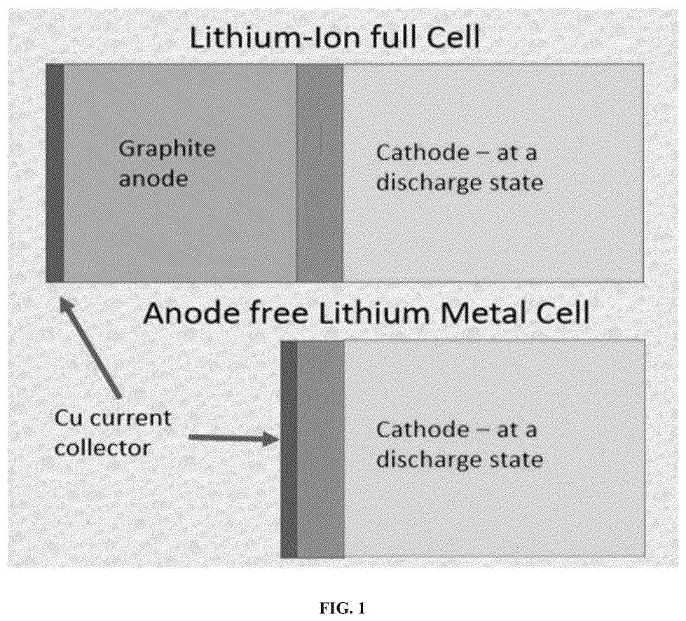

FIG. 2 presents a graph showing the capacity retention (CR) and coulombic efficiency (CE) of cells with 0.95 M LiPF₆+0.05 M LiBOB dissolved in EMC:DMC:FEC:PC 3:3:3:1 (v/v) upon addition of 0.5%, 1% or 2% Al₂O₃ particles, as a function of charge-discharge cycle number (reference sample without added Al₂O₃);

FIG. 3 presents a graph showing the capacity retention (CR) and coulombic efficiency (CE) of cells with 0.95 M LiPF₆+0.05 M LiBOB dissolved in EMC:DMC:FEC:PC 3:3:3:1 (v/v) upon addition of 0.5%, 1% or 2% TiO₂ particles, as a function of charge-discharge cycle number (reference sample without added TiO₂);

FIG. 4 presents a graph showing the capacity retention (CR) and coulombic efficiency (CE) of cells with 0.95 M LiPF₆+0.05 M LiBOB dissolved in EMC:DMC:FEC:PC 3:3:3:1 (v/v) upon addition of 0.5%, 1% or 2% SiO₂ particles, as a function of charge-discharge cycle number (reference sample without added SiO₂);

FIG. 5 presents a graph showing the capacity retention (CR) and coulombic efficiency (CE) of cells with 0.95 M LiPF₆+0.05 M LiBOB dissolved in EMC:DMC:FEC:PC 3:3:3:1 (v/v) upon addition of 1% Al₂O₃ or TiO₂ particles or 2% SiO₂ particles, as a function of charge-discharge cycle number (reference sample without added particles);

FIG. 6 presents a graph showing the capacity retention (CR) and coulombic efficiency (CE) of cells with 0.8 M LiBF₄ in 1:2 FEC:DEC, with and without 1% Al₂O₃ particles, as a function of charge-discharge cycle number;

FIG. 7 presents a graph showing the capacity retention (CR) and coulombic efficiency (CE) of cells with 0.95 M LiPF₆+0.05 M LiBOB dissolved in EMC:DMC:FEC:PC 3:3:3:1 (v/v) upon addition of 1% PMMA, PVDF or PEO particles, as a function of charge-discharge cycle number (reference sample without added particles);

FIG. 8 presents a graph showing the capacity retention (CR) and coulombic efficiency (CE) of cells with 0.95 M LiPF₆+0.05 M LiBOB dissolved in EMC:DMC:FEC:PC 3:3:3:1 (v/v) upon addition of 5% PMMA, PVP or PAN particles, as a function of charge-discharge cycle number (reference sample without added particles);

FIG. 9 presents a graph showing the capacity retention (CR) and coulombic efficiency (CE) of cells with 0.95 M LiPF₆+0.05 M LiBOB dissolved in EMC:DMC:FEC:PC 3:3:3:1 (v/v) upon addition of 1%, 5% or 15% PMMA particles, as a function of charge-discharge cycle number (reference sample without added particles);

FIG. 10 presents a graph showing the capacity retention (CR) and coulombic efficiency (CE) of cells with 0.95 M LiPF₆+0.05 M LiBOB dissolved in EMC:DMC:FEC:PC 3:3:3:1 (v/v) upon addition of 1% Al₂O₃ particles and/or 1% PVDF particles, as a function of charge-discharge cycle number (reference sample without added particles);

FIG. 11 presents a graph showing the capacity retention (CR) and coulombic efficiency (CE) of cells with 0.95 M LiPF₆+0.05 M LiBOB dissolved in EMC:DMC:FEC:PC 3:3:3:1 (v/v) upon addition of 1% Al₂O₃ particles and 1% or 5% PVDF particles, as a function of charge-discharge cycle number (reference sample without added particles);

FIG. 12 presents a graph showing the capacity retention (CR) and coulombic efficiency (CE) of NCA/Cu cells with 0.95 M LiPF₆+0.05 M LiBOB dissolved in EMC:DMC:FEC:PC 3:3:3:1 (v/v) upon addition of 0.5%, 1% or 2% In₂O₃ particles, as a function of charge-discharge cycle number (reference sample without added In₂O₃);

FIG. 13 presents a graph showing the capacity retention (CR) and coulombic efficiency (CE) of NCA/Cu cells with 0.95 M LiPF₆+0.05 M LiBOB dissolved in EMC:DMC:FEC:PC 3:3:3:1 (v/v) upon addition of 0.5%, 1% or 2% ZnO particles, as a function of charge-discharge cycle number (reference sample without added ZnO);

FIG. 14 presents a graph showing the capacity retention (CR) and coulombic efficiency (CE) of NCA/Cu cells with 0.95 M LiPF₆+0.05 M LiBOB dissolved in EMC:DMC:FEC:PC 3:3:3:1 (v/v) upon addition of 0.5%, 1% or 2% SnO₂ particles, as a function of charge-discharge cycle number (reference sample without added SnO₂);

FIG. 15 presents a graph showing the capacity retention (CR) and coulombic efficiency (CE) of NCA/Cu cells with 0.95 M LiPF₆+0.05 M LiBOB dissolved in EMC:DMC:FEC:PC 3:3:3:1 (v/v) upon addition of 0.5% SnO₂, 1% In₂O₃ and 1% ZnO particles, as a function of charge-discharge cycle number;

FIG. 16 presents a graph showing the discharge capacity of NCA/Si cells with 1 M LiPF₆ dissolved in EC:DEC 1:1 (v/v)+2% VC and 15% FEC, upon addition of 1% or 2% TiO₂ nanoparticles, as a function of charge-discharge cycle number; and

FIG. 17 presents a graph showing the capacity retention (CR) and coulombic efficiency (CE) of NMC/graphite cells with 1 M LiPF₆ dissolved in EC:DEC 1:1 (v/v)+2% VC and 15% FEC, upon addition of 1% Al₂O₃+1% CsAc, as a function of charge-discharge cycle number.

### DESCRIPTION OF SPECIFIC EMBODIMENTS OF THE INVENTION

The present invention, in some embodiments thereof, relates to electrochemistry, and more particularly, but not exclusively, to electrolyte compositions which can be used in an alkali metal battery.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

According to an aspect of some embodiments of the invention, there is provided an electrochemical cell which comprises a liquid electrolyte comprising (in addition to a liquid substance suitable for serving as an electrolyte, e.g., a liquid substance containing ions) at least one additive which is a nanoparticle dispersed in the liquid electrolyte and/or a polymer dissolved and/or dispersed in the liquid electrolyte.

In some of any of the embodiments described herein, the electrochemical cell further comprises an anode which comprises an alkali metal (e.g., in a metallic state) and/or a conductive solid suitable for deposition of the alkali metal thereupon (e.g., in a metallic state); and a cathode comprising a substance capable of reversibly absorbing and releasing ions of the alkali metal.

Herein, the phrase “alkali metal” encompasses lithium, sodium, potassium, rubidium and cesium and combinations thereof, and encompasses alkali metal atoms (e.g., metallic forms of alkali metals) and alkali metal cations (e.g., in solution and/or in a salt or a substance described herein).

Examples of suitable alkali metals include, without limitation, lithium, sodium and potassium. In exemplary embodiments, the alkali metal is lithium.

Herein and in the art, cells in which the anode lacks an alkali metal (e.g., comprises the conductive solid described herein, without the alkali metal) in the discharged state are referred to as “anode-free”. However, it is to be understood that such cells do comprise an anode as described herein (albeit an anode which may lack alkali metal), and may also comprise alkali metal when not in the discharged state (e.g., wherein the anode comprises an amount of alkali metal which is limited by the amount of alkali metal the cathode is capable of releasing).

Herein, the term “liquid electrolyte” refers to a substance which serves as an electrolyte in an electrochemical cell, and which as a whole is in a form of a liquid (e.g., a liquid layer between the anode and cathode). Thus, for example, electrolytes composed of a liquid absorbed into a non-liquid matrix are not to be considered a liquid electrolyte (even if they comprise a liquid as one of the components thereof). However, the liquid electrolyte may comprise a solid which is dissolved and/or dispersed therein (e.g., in a liquid solvent).

Herein the term “solvent” refers to any compound used to form a liquid, and is not intended to imply that any substance is necessarily dissolved therein. Thus, for example, a substantially pure liquid compound comprising solid particles dispersed therein is also referred to herein as a “solvent”.

In some of any of the respective embodiments described herein, the liquid electrolyte comprises at least one organic solvent (e.g., at least one liquid organic solvent). In some embodiments, the organic solvent is a one or more carbonate ester and/or one or more ether. Examples of suitable solvents which are a carbonate ester include, without limitation, dimethyl carbonate, ethyl methyl carbonate, diethyl carbonate, ethylene carbonate, fluoroethylene carbonate, vinylene carbonate and propylene carbonate. Examples of suitable solvents which are an ether include, without limitation, dimethyl ether, 1,3-dioxolane, triethylene glycol dimethyl ether, and polyethylene glycol. The polyethylene glycol is optionally terminated (at one or more terminus) by a hydrocarbon, such as an alkyl, for example, methyl). Alternatively or additionally, the polyethylene glycol is terminated by one or more hydroxy (—OH) group (e.g., derived from a glycol unit).

In some of any of the respective embodiments described herein, the liquid electrolyte comprises at least one alkali metal salt, optionally dissolved in a solvent according to any of the respective embodiments described herein. In some such embodiments, the alkali metal salt comprises (in addition to an ion of the alkali metal) a counter-ion such as hexafluorophosphate, trifluoromethanesulfonate, bis(trifluoromethane)sulfonimide, tetrafluoroborate, bis(oxalato)borate, and/or difluoro(oxalato)borate.

In some of any of the embodiments described herein, the cell further comprises a solid electrolyte and/or separator (e.g., a porous separator).

Solid electrolytes suitable for alkali metal-based cells described herein will be recognized by the skilled person. Alkali metal phosphorus oxynitrides (PON), such as lithium PON or sodium PON, are non-limiting examples of a suitable solid electrolyte.

As used herein and in the art, a “separator”, in the context of an alkali metal electrochemical cell, refers to a barrier (typically thin) which separates the anode and cathode in order to prevent a short circuit therebetween, yet which allows passage of alkali metal ions (e.g., a porous barrier). A separator may optionally be designed such that in the presence of overheating, the barrier becomes less permeable (e.g., by melting of a porous substance) so as to stop operation of the cell in such a case (e.g., as a safety feature).

The liquid electrolyte may optionally occupy substantially the entire space between the anode and cathode, or most of the space between the anode and cathode (e.g., wherein the remainder is occupied by a solid and/or gel, such as a separator according to any of the respective embodiments described herein).

Alternatively or additionally, the liquid electrolyte may optionally occupy no more than 50% or no more than 10% or no more than 1% of the space between the anode and cathode. In such embodiments, most of the space between the anode and cathode may optionally be occupied by a solid and/or gel, such as a separator and/or solid electrolyte according to any of the respective embodiments described herein (e.g., wherein the liquid electrolyte occupies a thin space between the solid and/or gel and the anode and/or cathode).

In some of any of the embodiments described herein, the liquid electrolyte is in a form of a thin (liquid) film, for example, between a solid electrolyte (according to any of the respective embodiments described herein) and the anode and/or between the solid electrolyte and the cathode. In some such embodiments, the solid electrolyte occupies most of the space between the anode and cathode. Such a thin film may optionally be known to as a conductive mediator thin film.

In some of any of the embodiments described herein relating to a thin film of liquid electrolyte, the liquid electrolyte comprises nanoparticles at a concentration in a range of from 0.5 to 5 weight percent (according to any of the respective embodiments described herein).

In some of any of the respective embodiments described herein, the thin film of liquid electrolyte is characterized by an average thickness in a range of from 10 nm to 10 μm, optionally from 100 nm to 5 μm.

Without being bound by any particular theory, it is believed that an electrochemical cell which comprises a solid electrolyte may benefit from the further presence of a liquid electrolyte (e.g., a thin film) by enhancing electrical contact (e.g., by lowering interfacial resistance and/or enhancing wettability of the surfaces) between the solid electrolyte and electrode (anode and/or electrode); as the contact between two solid surfaces (e.g., the solid electrolyte and electrode), without an intervening liquid electrolyte, may be poor due to the roughness of the surface(s).

In some of any of the respective embodiments described herein, a concentration of nanoparticles in the liquid electrolyte is in a range of from 0.1 to 10 weight percent; for example, from 0.1 to 0.4 weight percent, or from 0.4 to 1.5 weight percent, or from 1.5 to 4 weight percent, or from 4 to 10 weight percent.

Examples of compounds which may be comprised by nanoparticles (according to any of the respective embodiments described herein) include, without limitation, Al₂O₃, TiO₂, SiO₂, CeO₂, ZrO₂, Ag₂O, AgO, CuO, NiO, ZnO, ZnCO₃, SiC, SnO₂, In₂O₃, Fe₂O₃ and Ga₂O₃. In some exemplary embodiments, the nanoparticles comprise Al₂O₃, TiO₂, and SiO₂. As exemplified herein, particularly advantageous properties may be obtained using TiO₂ nanoparticles and/or Al₂O₃ nanoparticles.

In some of any of the respective embodiments described herein, a concentration of polymer in the liquid electrolyte (e.g., dissolved in the liquid electrolyte) is in a range of from 0.1 to 20 weight percent; for example, from 0.1 to 0.5 weight percent, or from 0.5 to 1.5 weight percent, or from 1.5 to 4 weight percent, or from 4 to 10 weight percent, or from 10 to 20 weight percent.

Examples of polymers compounds which may be included in the liquid electrolyte (according to any of the respective embodiments described herein) include, without limitation, polyacrylonitrile, polyvinyl pyrrolidone, polymethyl methacrylate, polyvinylidene difluoride, and polyethylene oxide, including copolymers thereof.

In some of any of the respective embodiments described herein, the polyethylene oxide is polyethylene oxide (e.g., terminated by hydroxyl groups) having a molecular weight in a range of from 3 kDa to 6 MDa, polyethylene oxide dimethyl ether having a molecular weight in a range of from 250 Da to 2 kDa, and/or polyethylene oxide monomethyl ether having a molecular weight in a range of from 350 Da to 5 kDa.

Herein, the phrase “reversibly absorbing and releasing ions of the alkali metal” refers to a substance as described herein, which encompasses a first form of the substance which has a relatively high (optionally stoichiometric) alkali metal content (e.g., in a form of alkali metal cations), and a second form of the substance having a relatively low (optionally zero or close to zero, for example, less than 10% by molar concentration) alkali metal content.

The phrase “reversibly absorbing and releasing” means that the second form of the substance is capable of absorbing, or absorbs, the alkali metal until the first form of the substance is obtained; the first form of the substance is capable of releasing, or releases, the alkali metal until the second form of the substance is re-obtained; and the re-obtained second form of the substance is capable of absorbing, or absorbs, the alkali metal until the first form of the substance is re-obtained.

In some of any of the respective embodiments, the substance capable of reversibly absorbing and releasing ions of the alkali metal comprises sulfur, FePO₄, MnO₂, CoO₂, NiₓCo_{y}Al_{1-x-y}O₂, NiₓCo_{y}Mn_{1-x-y}O₂, and alkalated forms thereof (wherein x and y are independently in a range of from 0 to 1, provided that the sum of x and y is no more than 1).

Herein, the term “alkalated” refers to a compound comprising an alkali metal (e.g., alkali metal ions), wherein the compound can reversibly release some or all of the alkali metal, resulting in a stable compound with less alkali metal or with no alkali metal (a “non-alkalated” compound). The alkalated compound and non-alkalated compound may be considered as different forms of a single compound having a variable amount of alkali metal, including amounts which are optionally intermediate between the fully alkalated forms and the non-alkalated forms described herein.

Examples of alkalated forms include, without limitation, Li₂S (an alkalated form of sulfur), LiFePO₄ (an alkalated form of FePO₄), LiMn₂O₄ (an alkalated form of MnO₂), LiCoO₂ (an alkalated form of CoO₂), LiNiₓCo_{y}Al_{1-x-y}O₂ (an alkalated form of NiₓCo_{y}Al_{1-x-y}O₂), and LiNiₓCo_{y}Mn_{1-x-y}O₂ (an alkalated form of NiₓCo_{y}Mn_{1-x-y}O).

In some of any of the embodiments described herein, a pressure within the electrochemical cell is at least (and optionally more than) 1 atmosphere, for example, in a range of from 1 to 20 atmospheres, and optionally from 2 to 5 atmospheres.

Such a pressure may optionally be obtained by packing the electrochemical cell under such a pressure when assembling the cell.

According to an aspect of some embodiments of the invention, there is provided a rechargeable alkali metal ion battery comprising at least one electrochemical cell according to any of the embodiments described herein. In some embodiments, the alkali metal is lithium, and the battery is a lithium ion battery.

Herein, the phrase “alkali metal ion battery” refers to a battery (e.g., comprising one or more electrochemical cells) wherein an electrochemical reaction which provides at least a portion of the electric power generated by the battery comprises movement of an alkali metal ion from one electrode (e.g., an anode) to another electrode (e.g., a cathode).

Herein, the phrase “lithium ion battery” refers to an alkali metal ion battery (as defined herein) wherein the alkali metal ion is lithium ion. The phrase “lithium ion battery” encompasses batteries in which the anode (at least when partially or fully charged) comprises lithium inserted into a solid matrix (e.g., graphite), as well as a “lithium metal battery”, in which the anode (at least when partially or fully charged) comprises lithium in a metallic state.

Herein, the phrase “rechargeable alkali metal ion battery” refers to an alkali metal ion battery (as defined herein) designed and/or identified for re-use upon recharging the battery by application of a suitable electric potential.

According to an aspect of some embodiments of the invention, there is provided a liquid electrolyte according to any of the respective embodiments described herein.

According to an aspect of some embodiments of the invention, there is provided a process of preparing an electrochemical cell according to any of the respective embodiments described herein, the process comprising contacting the liquid electrolyte with the cathode and/or the anode (e.g., wherein a cathode is placed in proximity to the anode, with the liquid electrolyte therebetween). In some such embodiments, the process further comprises contacting the liquid electrolyte with a solid electrolyte (e.g., a solid electrolyte placed between the anode and cathode).

In some of any of the embodiments described herein relating to a process, the anode comprises the conductive solid substantially devoid of the alkali metal. By such a process one may obtain the electrochemical cell in a discharged state, wherein the cathode is in an alkalated form (that is, the substance capable of reversibly absorbing and releasing ions of the alkali metal, which substance is comprised by the cathode, is in an alkalated form, as defined herein). In some such embodiments, the process further comprising applying an electric potential between the conductive solid and the cathode such that the alkali metal deposits (e.g., in a metallic form) on the conductive solid (e.g., upon migration of alkali metal ions from the cathode via the electrolyte to the anode), to thereby obtain the electrochemical cell in a charged state.

Without being bound by any particular theory, it is believed that the process beginning with a conductive solid substantially devoid of the alkali metal is characterized by enhanced simplicity and/or low cost.

In some of any of the embodiments described herein relating to a process, the anode comprises the conductive solid coated with a layer of the alkali metal, for example, wherein an average thickness of the layer of the alkali metal is in a range of from 0.1 to 20 μm.

Without being bound by any particular theory, it is believed that the process beginning with a conductive solid substantially devoid of the alkali metal is characterized by enhanced quality (e.g., cell cycle life) of the obtained cell.

In some embodiments, the conductive solid used in the anode is a substance selected from the group consisting of silicon, a silicon alloy, carbon, graphite, nickel, copper, and a stainless foil. In some embodiments, the silicon comprises nanoparticles, other silicon nano-structures and silicon micro-particles. In some embodiments, the silicon alloy comprises from 1 wt. % to 30 wt. % of Ni, Cu, Co and Fe. In some embodiments, the carbon is in the form of carbon powder or graphite and other carbon allotropes. In some embodiments, the stainless foil is a commercially available stainless steel foil having a thickness of 10 to 300 microns.

It is expected that during the life of a patent maturing from this application many relevant battery components and designs will be developed and the scope of the terms “anode”, “cathode”, “electrolyte”, “battery”, “electrochemical cell” and the like are intended to include all such new technologies a priori.

Herein, an “average” refers to the mean (unless explicitly indicated otherwise).

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

### NCA/Cu Cells:

Coin cells (CR2032) were assembled in an Ar-atmosphere glove box (MBraun), with 0.1 ppm H₂O and O₂, each. Two layers of Celgard® 2400 separator were placed between 12 mm-diameter NCA (811) cathode (Tadiran Batteries Ltd.) and 15 mm-diameter copper foil (Schlenk). Average NCA areal capacity was ˜3.24 mAh/cm². Four stainless-steel (SS) spacers and one SS spring were inserted in each coin cell, forcing contraction of the spring to apply external pressure of ˜5.3 atmospheres on the NCA cathode (estimated from calibration curve of force vs. contraction distance for the SS spring, and the thickness of each component of the coin cell). The reference electrolyte (Soul Brain) was composed of 0.95 M LiPF₆+0.05 M LiBOB (lithium bis(oxalato)borate) dissolved in EMC:DMC:FEC:PC 3:3:3:1 (v/v). 0.5%, 1%, or 2% (w/w) of TiO₂ (US Research Nanomaterials, Inc., 18 nm APS), Al₂O₃ (Nanografi Nano Technology, 4 nm APS), SiO₂ (Aldrich, 11 nm APS), CuO (Aldrich, <50 nm particle size), Ag₂O (Nanoshel LLC. 50 nm APS), ZrO₂-3Y (US Research Nanomaterials, Inc., 40 nm APS), CeO₂ (US Research Nanomaterials, Inc., 10 nm APS), and SiC (US Research Nanomaterials, Inc., 25-45 nm particle size) nanoparticles, or 1-15% (w/w) of PVDF (Kynar), PMMA (very high molecular weight) powder (Sigma-Aldrich), PAN (150000 Da) powder (Sigma-Aldrich), PEO (˜5000000 Da) powder (Sigma-Aldrich) and PVP (8000 Da) powder (Alfa Acsar), were dispersed in the reference electrolyte. The electrolyte volume that was used in each cell was 60 μL. The cells were left under open circuit voltage at 30° ° C. for 24 hours before testing. The cells were cycled between 4.25-3.0 V at C/10 (366 μA), over all cycles. Cycling tests and electrochemical-impedance-spectroscopy (EIS) measurements were carried out with the use of BCS or VMP3 system (Biologic). EIS measurements were taken over a frequency range of 0.1 Hz to 1 MHZ, and their spectra were analyzed by EC-Lab software. Surface environmental scanning electron microscope micrographs and EDS (energy dispersive X-ray spectroscopy) analyses were performed using a Quanta 200 FEG ESEM™ system. X-ray photoelectron spectroscopy (XPS) measurements were performed under ultra-high vacuum conditions (2.5×10⁻¹⁰ Torr base pressure) with the use of a scanning 5600 Multi-Technique System (PHI, USA). The samples were irradiated with an Al K_{α} monochromatic source (1486.6 eV) and the emitted electrons were analyzed by a spherical capacitor analyzer with a slit aperture of 0.8 mm. Depth profiling was performed with a 4 kV Ar⁺ ion gun (sputter rate was 56.3 Å/min on a SiO/Si reference).

Another type of coin cells (CR2032) were assembled in an Ar-atmosphere glove box (MBraun), with 0.1 ppm H₂O and O₂, each. Two layers of Celgard® 2400 separator were placed between 12 mm-diameter NCA (811) cathode and 15 mm-diameter copper foil. Average NCA areal capacity was ˜3.24 mAh/cm². Four stainless-steel (SS) spacers and one SS spring were inserted in each coin cell, forcing contraction of the spring to apply pressure of ˜5.3 atmospheres on the NCA cathode. The reference electrolyte (Soul Brain) was composed of 0.95 M LiPF₆+0.05 M LiBOB (lithium bis(oxalato)borate) dissolved in EMC:DMC:FEC:PC 3:3:3:1 (v/v). 0.5%, 1%, or 2% (w/w) of ZnO (Nanoshel, 10-30 [nm] APS), SnO₂ (US Research Nanomaterials, Inc. 18 [nm] APS) and In₂O₃ (US Research Nanomaterials, Inc. 20-70 [nm] APS) were dispersed (each one separately) in the reference electrolyte. The electrolyte volume in each cell was 60 μL. The cells left under open circuit voltage at 30° C. for 24 hours before testing. The cells were cycled between 4.25-3.0 V at C/10 (366 μA), over all cycles.

### NCA/Si Cells:

Coin cells (CR2032) were assembled in an Ar-atmosphere glove box (MBraun), with 0.1 ppm H₂O and O₂, each. Two layers of Celgard® 2400 separator were placed between NCA (811) cathode and Si anode. The Si anode was lab-made with micron-scale Si particles. Average NCA and Si areal capacity was ˜3.24 mAh/cm² and ˜3.7 mAh/cm², respectively. Two stainless-steel (SS) spacers and one SS spring were inserted in each coin cell. The reference electrolyte was 1 M LiPF₆ dissolved in EC:DEC 1:1 (v/v)+2% VC and 15% FEC. 1% and 2% of TiO₂ were dispersed (each one separately) in the reference electrolyte. The electrolyte volume was 60 μL. The cells were cycled between 4.1-2.8 V at ˜650 μA/cm² (while charging) and ˜1.1 mA/cm² (while discharging).

### NMC/Graphite Cells:

Coin cells (CR2032) were assembled in an Ar-atmosphere glove box (MBraun), with 0.1 ppm H₂O and O₂, each. Two layers of Celgard® 2400 separator were placed between 12 mm-diameter NMC (622) cathode (NEI corporation) and 10 mm-diameter graphite anode. Average NMC and graphite areal capacities were ˜2 mAh/cm² and ˜1.65 mAh/cm² respectively. Two stainless-steel (SS) spacers and one SS spring were inserted in each coin cell. The reference electrolyte was 1 M LiPF₆ dissolved in EC:DEC 1:1 (v/v)+2% VC and 15% FEC. 1% of Al₂O₃+1% of Cesium trifluoroacetate (CsAc) were dispersed (each one separately) in the reference electrolyte. The electrolyte volume was 60 μL. The cells were cycled between 2.8-3.75V at C/4 (393 μA), whereas the formation cycle was C/10 (157 μA).

### Analysis Data for all Cell Types:

Cycling tests and electrochemical-impedance-spectroscopy (EIS) measurements were carried out with the use of BCS or VMP3 system (Biologic). EIS measurements were taken over a frequency range of 0.1 Hz to 1 MHZ, and their spectra were analyzed by EC-Lab software. Surface environmental scanning electron microscope micrographs and EDS (energy dispersive X-ray spectroscopy) analyses were performed using a Quanta 200 FEG ESEM™ system. X-ray photoelectron spectroscopy (XPS) measurements were performed under ultra-high vacuum conditions (2.5×10⁻¹⁰ Torr base pressure) with the use of a scanning 5600 Multi-Technique System (PHI, USA). The samples were irradiated with an Al K_{α} monochromatic source (1486.6 eV) and the emitted electrons were analyzed by a spherical capacitor analyzer with a slit aperture of 0.8 mm. Depth profiling was performed with a 4 kV Ar⁺ ion gun (sputter rate was 56.3 Å/min on a SiO/Si reference).

### Results and Discussion

Anode-free NCA/Cu cells were assembled with three types of electrolyte:
a) 0.95 M LiPF₆+0.05 M LiBOB (lithium bis(oxalato)borate) dissolved in EMC (ethyl methyl carbonate:DMC (dimethyl carbonate):FEC (fluoroethylene carbonate):PC (propylene carbonate) 3:3:3:1 (v/v) (type 1 electrolyte),
b) 0.85 M LiPF₆+2% VC (vinylene carbonate) and 15% FEC (fluoroethylene carbonate) dissolved in EC (ethylene carbonate):DEC (diethyl carbonate) 1:1 (v/v) (type 2 electrolyte), and
c) 0.8 M LiBF₄ in FEC:DEC 1:2 (v/v) (type 3 electrolyte), with or without addition of 0.5%-2% (w/w) Al₂O₃, TiO₂ and SiO₂ nanoparticles, or 1%-15% (w/w) of PVDF (polyvinylidene difluoride), PMMA (polymethyl methacrylate), PAN (polyacrylonitrile), PEO (polyethylene oxide) and PVP (polyvinyl pyrrolidone).

All the cells were cycled at C/10 (366 μA) where the charge cut-off voltage was 4.25 V and the discharge cut-off voltage was 3.0 V, and were stopped at 70% CR (capacity retention). As the highest discharge capacity in the initial cycles was obtained at a different cycle for each cell type (range from cycle 2 until 4), the initial discharge capacity for each cell was calculated as the average capacity of discharge 2 until 4 (it is noted that the discharge capacity varied by a small amount between cycles 2, 3 and 4). The coulombic efficiency (CE, defined as 100·Q_{discharge}/Q_{charge})) was calculated as an average from cycle 2 until the cycle at which the cell reached 70% CR.

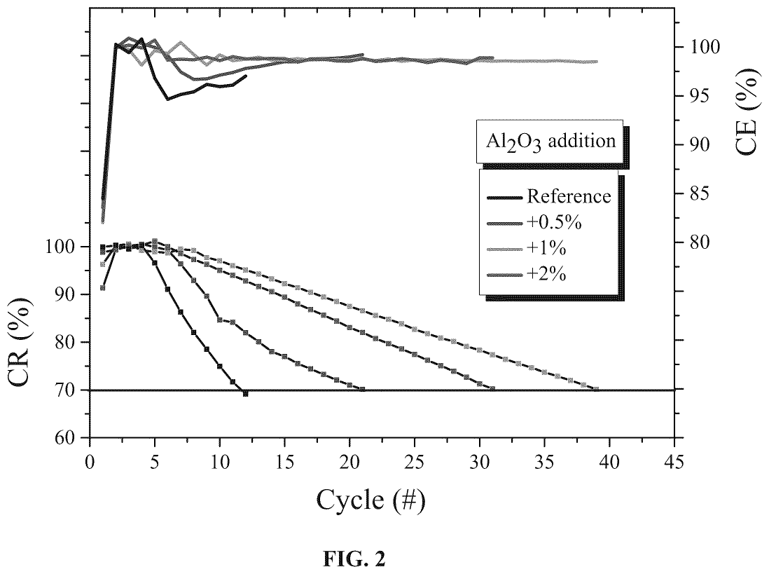

As shown in FIG. 2 and in Table 1 below, the addition of Al₂O₃ significantly increases the CE of the cells compared to the reference cell. Addition of 0.5% Al₂O₃ exhibited the smallest increase, with a CE of 98.57% (an increase of 1.50% vs the reference cell), and addition of 1% and 2% Al₂O₃ exhibited the highest increases, with CEs of 98.81% and 98.89%, respectively (increases of 1.74% and 1.82% vs. the reference cell).

As further shown in FIG. 2, capacity retention (CR) is similarly enhanced: whereas the reference cell reaches 70% CR after 12 cycles, addition of 0.5% Al₂O₃ resulted in 70% CR after 21 cycles, and addition of 1% Al₂O₃ resulted in 70% CR after 39 cycles.

Upon comparison of the different Al₂O₃ addition concentrations, 1% Al₂O₃ exhibited the highest performance, with a higher CE and three times higher stability.

TABLE 1
cycle-life parameters of cells with 0.5%, 1% or 2% Al₂O₃ particles
or reference cell without Al₂O₃ (using 0.95M LiPF₆ + 0.05M
LiBOB dissolved in EMC:DMC:FEC:PC 3:3:3:1 (v/v) as electrolyte)

| | CE (%) | 70% CR | CE (%) |
|---|---|---|---|
| Al₂O₃ Additive | cycle 2 - 70% CR | (cycle #) | 1st cycle |
| reference | 97.07 | 12 | 84.45 |
| 0.5% | 98.57 | 21 | 83.56 |
| 1% | 98.81 | 39 | 82.01 |
| 2% | 98.89 | 31 | 82.22 |

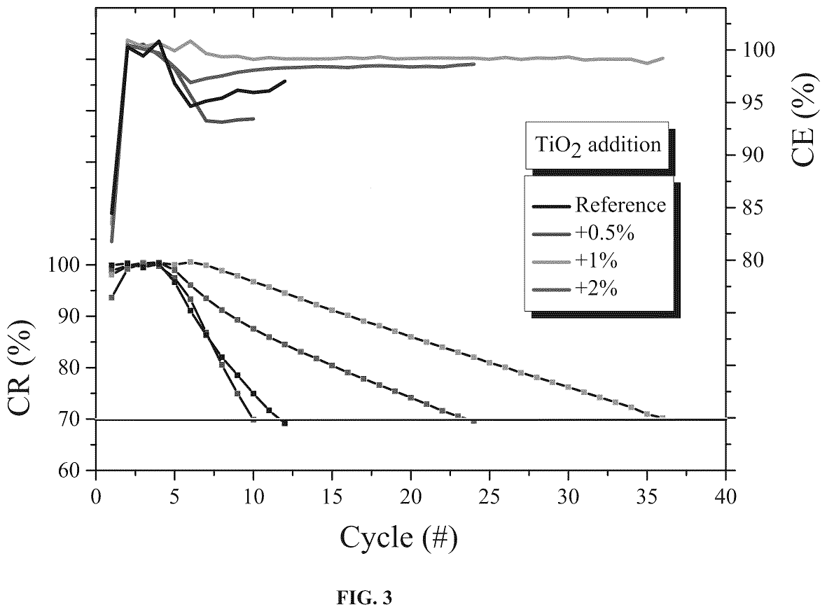

As shown in FIG. 3 and in Table 2 below, addition of 0.5% TiO₂ did not appear to affect the CE or CR; whereas addition of 1% TiO₂ exhibited the most enhanced performance, with a CE of 99.39% (an increase of 2.32% vs. the reference cell), and a three-fold increase in stability, with 70% CR after 36 cycles (rather than 12 in the reference cell), and it exhibited the best stability among the different TiO₂ concentrations.

TABLE 2
cycle-life parameters of cells with 0.5%, 1% or 2% TiO₂ particles
or reference cell without TiO₂ (using 0.95M LiPF₆ + 0.05M
LiBOB dissolved in EMC:DMC:FEC:PC 3:3:3:1 (v/v) as electrolyte)

| | CE (%) | 70% CR | CE (%) |
|---|---|---|---|
| TiO₂ Additive | cycle 2 - 70% CR | (cycle #) | 1st cycle |
| reference | 97.07 | 12 | 84.45 |
| 0.5% | 96.36 | 10 | 83.44 |
| 1% | 99.39 | 36 | 83.42 |
| 2% | 98.44 | 24 | 81.76 |

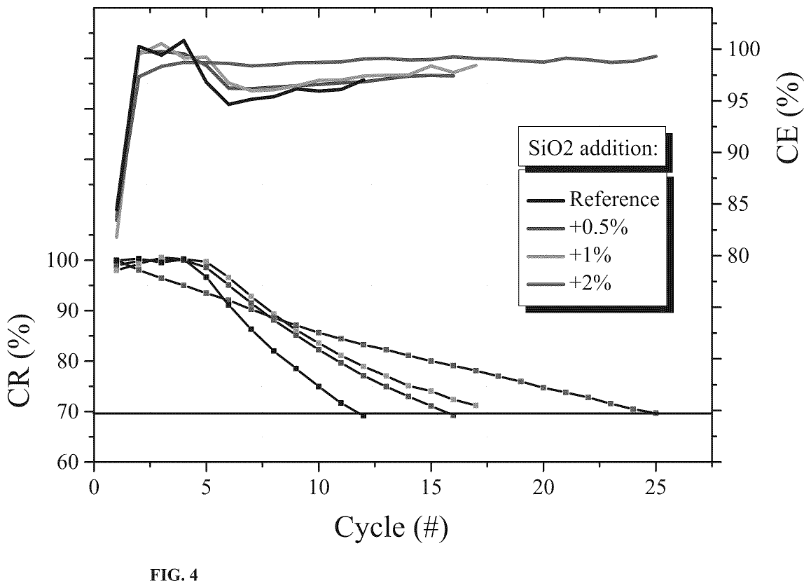

As shown in FIG. 4 and in Table 3 below, addition of either 0.5% or 1% SiO₂ did not appear to significantly improve the CE or the CR; whereas addition of 2% SiO₂ enhanced the cycling performance with a CE of 98.79% (an increase of 1.72% vs. the reference cell), and a CR of 70% after 25 cycles (rather than 12 in the reference cell).

TABLE 3
cycle-life parameters of cells with 0.5%, 1% or 2% SiO₂ particles
or reference cell without SiO₂ (using 0.95M LiPF₆ + 0.05M
LiBOB dissolved in EMC:DMC:FEC:PC 3:3:3:1 (v/v) as electrolyte)

| | CE (%) | 70% CR | CE (%) |
|---|---|---|---|
| SiO₂ Additive | cycle 2 - 70% CR | (cycle #) | 1st cycle |
| reference | 97.07 | 12 | 84.45 |
| 0.5% | 97.48 | 16 | 83.42 |
| 1% | 97.80 | 17 | 81.76 |
| 2% | 98.79 | 25 | 83.79 |

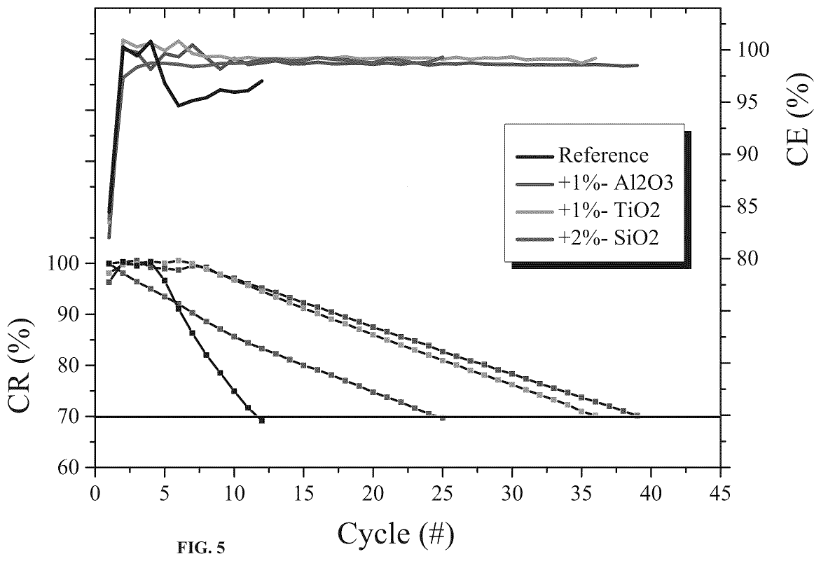

The performance of typical performing cells for the Al₂O₃, TiO₂, and SiO₂ nanoparticle additives, as well as other tested nanoparticles, is summarized in FIG. 5 and in Table 4 below.

As shown in FIG. 5 and Table 4, among all additives, TiO₂ exhibited the most pronounced effect, with 1% addition as the optimal concentration, resulting in a CE of 99.39% and CR of 70% after 36 cycles.

TABLE 4
cycle-life parameters of cells with various ceramic
nanoparticles or reference cell without nanoparticles (using
0.95M LiPF₆ + 0.05M LiBOB dissolved in EMC:DMC:FEC:PC
3:3:3:1 (v/v) as electrolyte)

| | CE (%) | 70% CR | CE (%) |
|---|---|---|---|
| Additive | cycle 2 - 70% CR | (cycle #) | 1st cycle |
| reference | 97.07 | 12 | 84.45 |
| 1% Al₂O₃ | 98.81 | 39 | 82.01 |
| 1% TiO₂ | 99.39 | 36 | 83.42 |
| 2% SiO₂ | 98.79 | 25 | 83.79 |
| 0.75% TiO₂ + 0.75% Al₂O₃ | 99.17 | 32 | 83.75 |
| 2% ZrO₂—3Y | 97.71 | 19 | 83.15 |
| 1% SiC | 98.02 | 22 | 82.43 |
| 1% CeO₂ | 97.03 | 18 | 84.40 |
| 1% CuO | 98.39 | 28 | 82.50 |
| 1% Ag₂O | 98.69 | 33 | 83.22 |

In order to assess whether the positive effect of the nanoparticles is restricted to electrolytes based on LiPF₆, cycling data was determined for a cell comprising 0.8M LiBF₄ in FEC:DEC 1:2 (v/v) with an addition of 1% Al₂O₃. In addition, another cell with a different carbonate-based electrolyte, comprising 0.85 M LiPF₆+2% VC and 15% FEC dissolved in EC:DEC 1:1 (v/v), was also tested with an addition of 1% Al₂O₃, and its cycling performance was compared to the other two electrolyte types described herein.

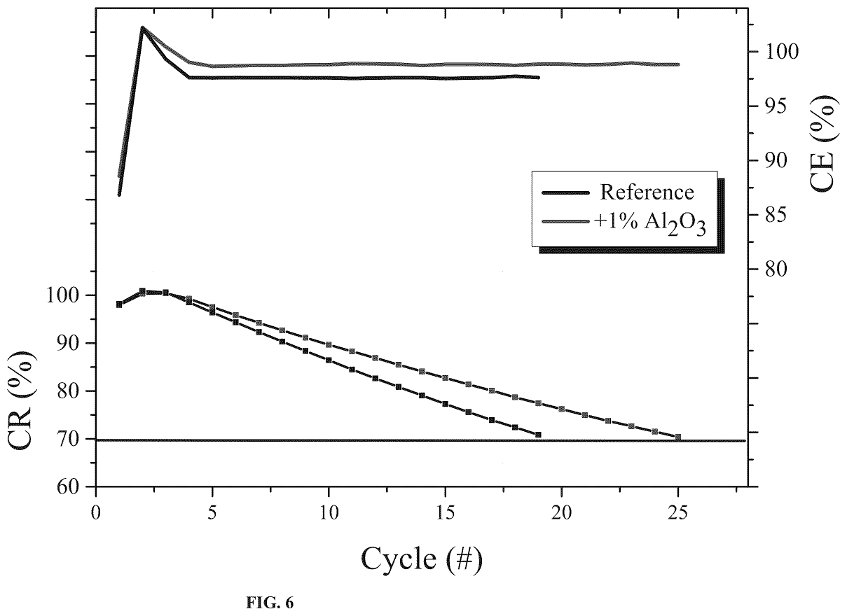

As shown in FIG. 6 and in Table 5 below, with an electrolyte based on LiBF₄, the 1% Al₂O₃ addition also increased the CE and CR values compared to the reference cell (the cell exhibited a CE of 99.03% and 70% CR at cycle 25, an increase of 1.14% and 6 cycles compared to the reference cell); but with an electrolyte based on LiPF₆, the increase was more significant.

These results suggest that the optimal additive may differ for different electrolytes and for different current densities.

Without being bound by any particular theory, it is believed that the beneficial effects of 0.5% to 2% nano-ceramic particles in the electrolytes are associated with their effect on the properties of the SEI (thickness, composition, and morphology) and on the morphology of the lithium deposition.

TABLE 5
cycle-life parameters of cells with 1% Al₂O₃ particles
for 3 different electrolyte types (type 1 = 0.95M
LiPF₆ + 0.05M LiBOB in EMC:DMC:FEC:PC 3:3:3:1 (v/v), type 2 =
0.85M LiPF₆ + 2% VC and 15% FEC in EC:DEC 1:1 (v/v), and
type 3 = 0.8M LiBF₄ in FEC:DEC 1:2 (v/v))

| | CE (%) | 70% CR | CE (%) |
|---|---|---|---|
| Electrolyte | cycle 2 - 70% CR | (cycle #) | 1st cycle |
| Type 1 | 98.81 | 39 | 82.01 |
| Type 2 | 98.79 | 33 | 84.54 |
| Type 3 | 99.03 | 25 | 88.53 |

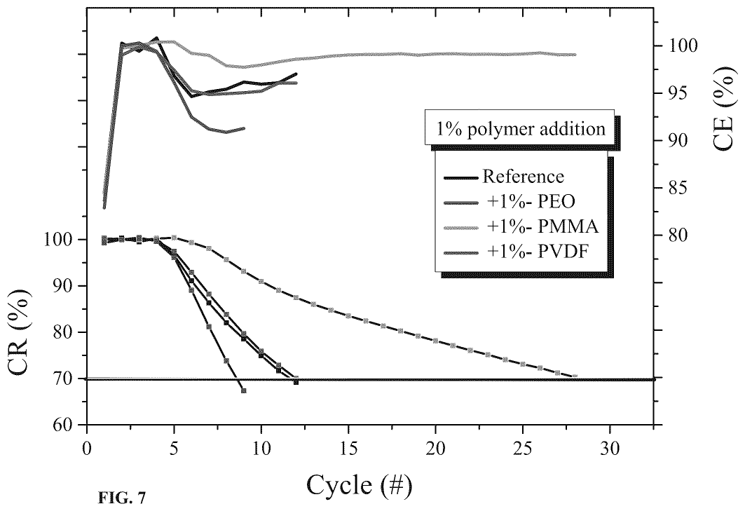

As shown in FIG. 7, addition of 1% PMMA resulted in better performance than did 1% PVDF or PEO; with a 70% CR after 28 cycles, about 2.3 times that of the reference electrolyte, and with enhancement of the CE of the cell from 97.07% to 99.02%.

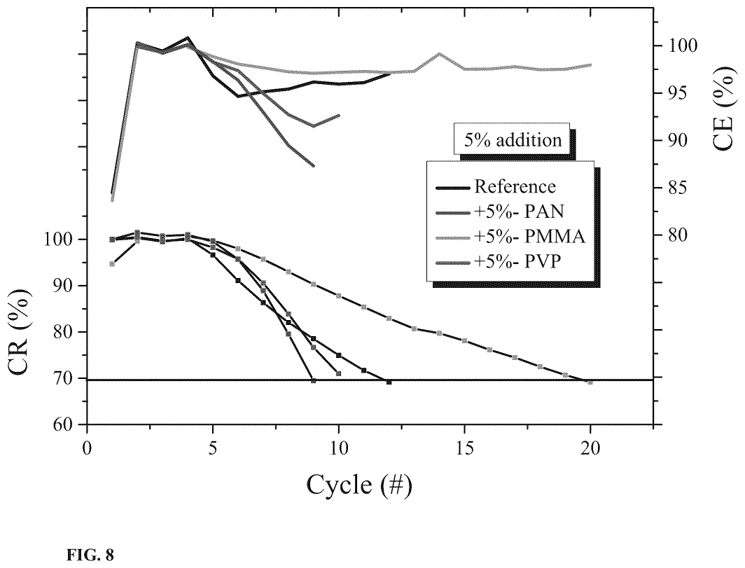

As shown in FIG. 8, addition of 5% PMMA resulted in better cycling performance than did 5% PVP or PAN; with PVDF or PEO.

These results indicate that PMMA is particularly effective (as compared to other polymers) at enhancing the CR and CE of cells.

Without being bound by any particular theory, it is believed that PMMA enhances performance by stabilizing of the SEI layer, because of its affinity for the electrolytes, as a result of the presence of ester groups [Zhu et al., J Energy Chem 2019, 37:126-142].

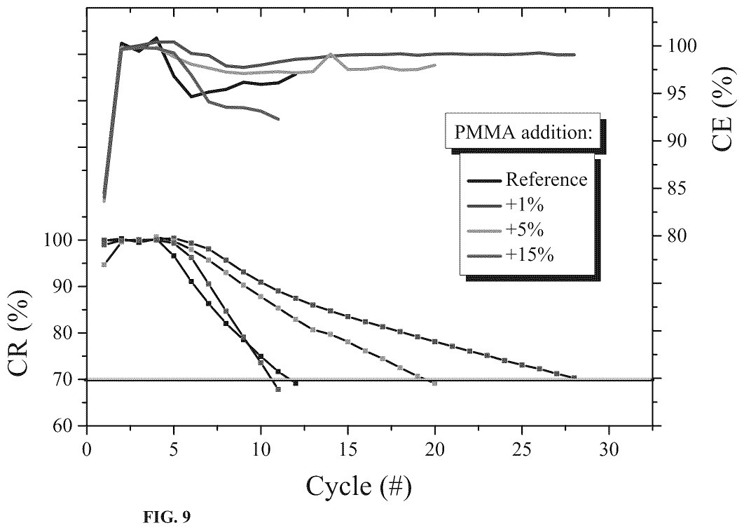

As shown in FIG. 9, addition of a higher amount (15%) of PMMA was associated with decreased cycling performance, 70% CR after 11 cycles, and CE of 96.20%.

Without being bound by any particular theory, it is believed that degradation of the cycling performance of the cells with increasing amount of PMMA is associated with increased viscosity of the electrolyte solution, which can lead to reduced Li-ion mobility, and decreased wettability of the separator and the electrodes.

As the addition of 1% Al₂O₃ was shown hereinabove to significantly improve cycling performance of cells, the combination of 1% Al₂O₃ and polymer in the electrolyte was examined.

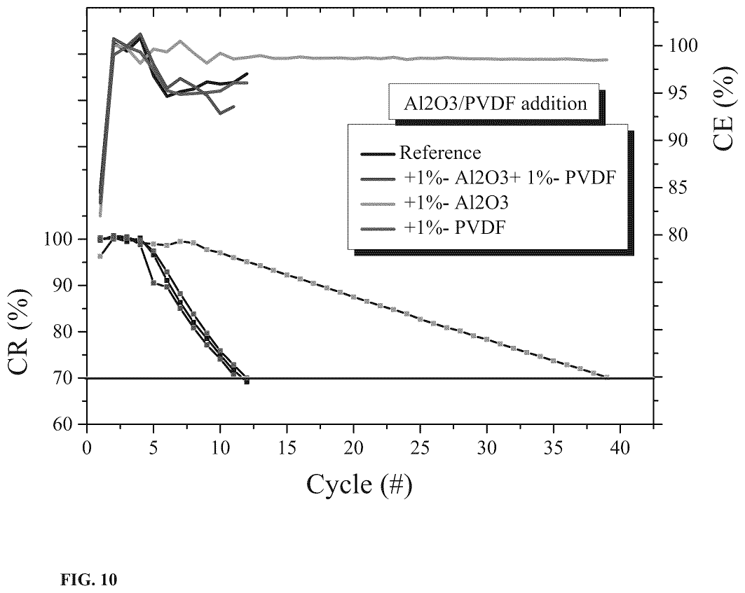

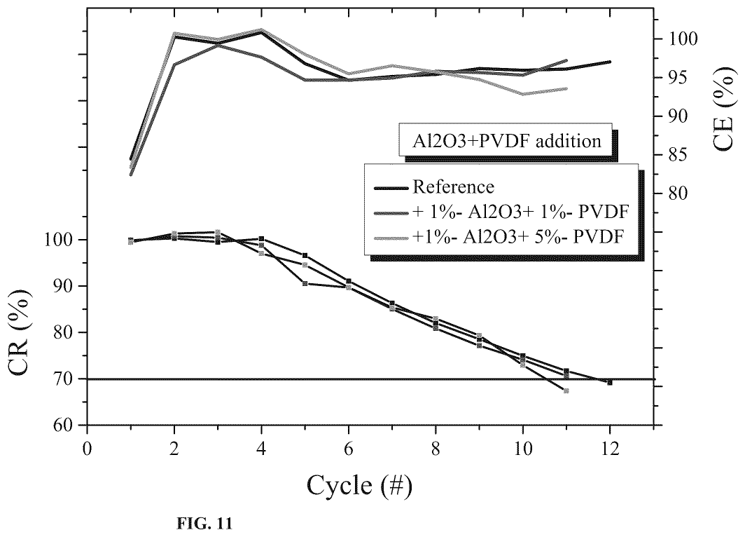

As shown in FIGS. 10 and 11, addition of 1% Al₂O₃ to electrolyte containing 1% or 5% PVDF did not improved the CR and CE of cells, in contrast to the addition of Al₂O₃ alone.

Without being bound by any particular theory, it is believed that this behavior may be associated with aggregation of the Al₂O₃ particles in the presence of PVDF, which hinders their influence on the cyclability.

The cycling performance data for all the polymer-based cells with 0.95 M LiPF₆+0.05 M LiBOB dissolved in EMC:DMC:FEC:PC 3:3:3:1 (v/v) are summarized in Table 6; and the cycling performance data for cells with 0.85 M LiPF₆ dissolved in EC:DEC 1:1, VC 2% (w/w), FEC 15% (v/v) for variety of polymer and ceramic nanoparticle combinations is summarized in Table 7.

TABLE 6
cycle-life parameters of cells with various polymeric
particles and/or ceramic particles or reference cell without
particles (using 0.95M LiPF₆ + 0.05M LiBOB dissolved
in EMC:DMC:FEC:PC 3:3:3:1 (v/v) as electrolyte)

| | CE (%) | 70% CR | CE (%) |
|---|---|---|---|
| Additive | cycle 2 - 70% CR | (cycle #) | 1st cycle |
| reference | 97.07 | 12 | 84.45 |
| 1% Al₂O₃ | 98.81 | 39 | 82.01 |
| 1% PMMA | 99.02 | 28 | 84.52 |
| 5% PMMA | 97.92 | 20 | 83.64 |
| 1% PMMA + 1% Al₂O₃ | 99.89 | 13 | 84.23 |
| 1% PVDF | 96.60 | 12 | 83.57 |
| 1% PVDF + 1% Al₂O₃ | 96.19 | 12 | 82.41 |
| 15% PMMA | 96.20 | 11 | 84.04 |
| 5% PVDF + 1% Al₂O₃ | 96.87 | 11 | 83.39 |
| 5% PVP | 95.83 | 11 | — |
| 2% PMMA + 1% Al₂O₃ | 95.91 | 10 | 83.71 |
| 5% PAN | 95.50 | 9 | — |
| 1% PEO | 95.21 | 9 | 82.88 |
| 2% PMMA | 94.75 | 8 | 82.67 |

TABLE 7
cycle-life parameters of cells with various polymeric
particles and/or ceramic particles or reference cell without
particles (using 0.85M LiPF₆ dissolved in EC:DEC 1:1,
VC 2% (w/w), FEC 15% (v/v) as electrolyte)

| | CE (%) | 70% CR | CE (%) |
|---|---|---|---|
| Additive | cycle 2 - 70% CR | (cycle #) | 1st cycle |
| reference | 98.32 | 24 | 83.76 |
| 1% PEO + 1% Al₂O₃ | 98.65 | 35 | 84.84 |
| 1% Al₂O₃ | 98.79 | 33 | 84.54 |
| 0.75% TiO₂ + 0.75% Al₂O₃ | 98.77 | 32 | 83.76 |
| 1% PEO | 98.82 | 30 | 84.04 |
| 1% TiO₂ | 98.56 | 29 | 83.44 |
| 1% PEO + 1% TiO₂ | 98.42 | 29 | 84.61 |

Additional cells are constructed as described herein, and the cycling performance determined as described herein, except that the nanoparticles added to the electrolyte are 1% ZnO, 1% ZnCO₃, 1% SnO₂, 1% In₂O₃, 1% Ga₂O₃ or 4% TiO₂, added to a cell with 0.95 M LiPF₆+0.05 M LiBOB dissolved in EMC:DMC:FEC:PC 3:3:3:1 (v/v) as electrolyte (type 1), or the polymeric powder added to such a cell is selected from:
1% PMMA+1% PVDF;
0.2% or 0.5% PMMA;
0.3% PMMA+1% Al₂O₃;
0.3% PMMA+2% SiO₂;
0.2% PMMA+2% TiO₂;
0.5% PVDF;
0.5% PEO;
0.5% PVP;
0.5% PAN;
0.5% LiPAA (lithium polyacrylic acid);
0.5% LiPAA+Al₂O₃;
0.5% Nafion™ (sulfonated tetrafluoroethylene based fluoropolymer-copolymer); and
0.5% Nafion™+Al₂O₃.

Additional cells are constructed as described herein (with a lithium iron phosphate (LFP) cathode), and the cycling performance determined as described herein, except that the electrolyte is 0.85 M LiPF₆ dissolved in EC:DEC 1:1, VC 2% (w/w), FEC 15% (v/v) (type 2), and the polymeric powder added to such a cell is selected from:
1% PEO+1% TiO₂;
1% PEO+2% SiO₂;
1% PMMA;
1% PAN;
1% PVP;
1% PVDF;
0.5% LiPAA;
0.5% Nafion™;
0.2% PMMA+1% Al₂O₃;
0.3% PMMA+2% SiO₂; and
0.2% PMMA+1% TiO₂.

Additional cells are constructed as described herein, and the cycling performance determined as described herein, except that the electrolyte is an ether-based electrolyte suitable for a lithium battery, such as dimethyl ether, 1,3-dioxolane, triethylene glycol dimethyl ether, and/or polyethylene glycol (optionally in a form of a monomethyl or dimethyl ether).

### Additional NCA/Cu Cells:

Anode-free NCA/Cu cells were assembled with an electrolyte consisting of 0.95 M LiPF₆+0.05 M LiBOB (lithium bis(oxalato)borate) dissolved in EMC (ethyl methyl carbonate: DMC (dimethyl carbonate): FEC (fluoroethylene carbonate): PC (propylene carbonate) 3:3:3:1 (v/v), with or without addition of 0.5%-2% (w/w) In₂O₃, ZnO and SnO₂ nanoparticles.

All the cells were stopped at 70% CR (capacity retention). As the highest discharge capacity in the initial cycles was obtained at a different cycle for each cell type (range from cycle 2 until 4), the initial discharge capacity for each cell was calculated as the average capacity of discharge 2 until 4 (it is noted that the discharge capacity varied by a small amount between cycles 2, 3 and 4). The coulombic efficiency (CE, defined as 100·Q_{discharge}/Q_{charge})) was calculated as an average from cycle 2 until the cycle at which the cell reached 70% CR.

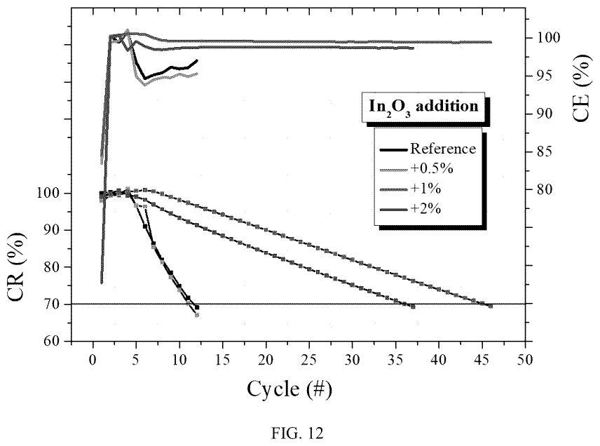

The reference cell showed CE of 97.1%. As shown in FIG. 12 and in Table 8, the addition of In₂O₃ significantly increases the CE compared to the reference cell. Addition of 0.5% In₂O₃ exhibited the smallest increase, with a CE of 96.2%, and addition of 1% and 2% In₂O₃ exhibited the highest increases, with CEs of 99.6% and 98.8%, respectively.

As further shown in FIG. 12, capacity retention (CR) is similarly enhanced: whereas the reference cell reaches 70% CR after 12 cycles, addition of 1% In₂O₃ resulted in 70% CR after 46.

TABLE 8
cycle-life parameters of NCA/Cu cells with 0.5%,
1% or 2% In₂O₃ particles or reference cell without In₂O₃ (using
0.95M LiPF₆ + 0.05M LiBOB dissolved in EMC:DMC:FEC:PC
3:3:3:1 (v/v) as electrolyte).

| | CE (%) | 70% CR | CE (%) |
|---|---|---|---|
| In₂O₃ Additive | cycle 2 - 70% CR | (cycle #) | 1st cycle |
| reference | 97.1 | 12 | 84 |
| 0.5% | 96.2 | 12 | 83.4 |
| 1% | 99.6 | 46 | 84.6 |
| 2% | 98.8 | 37 | 67.7 |

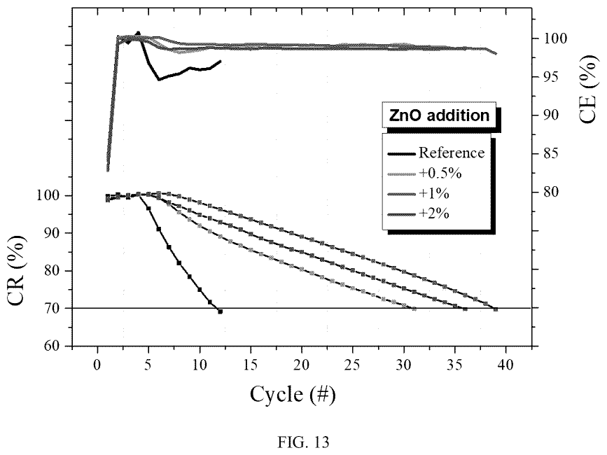

As shown in FIG. 13 and in Table 9 below, the addition of ZnO significantly increases the CE compared to the reference cell. Addition of 0.5% ZnO exhibited a CE of 99.1%, and addition of 1% and 2% ZnO exhibited CEs of 99.2% and 98.8%, respectively.

As further shown in FIG. 13, capacity retention (CR) is similarly enhanced: whereas the reference cell reaches 70% CR after 12 cycles, addition of 1% ZnO resulted in 70% CR after 39

TABLE 9
cycle-life parameters of NCA/Cu cells with 0.5%,
1% or 2% ZnO particles or reference cell without ZnO (using
0.95M LiPF₆ + 0.05M LiBOB dissolved in EMC:DMC:FEC:PC
3:3:3:1 (v/v) as electrolyte)

| ZnO | CE (%) | 70% CR | CE (%) |
|---|---|---|---|
| Additive | cycle 2 - 70% CR | (cycle #) | 1st cycle |
| reference | 97.1 | 12 | 84.4 |
| 0.5% | 99.1 | 31 | 84.2 |
| 1% | 99.2 | 39 | 84.1 |
| 2% | 98.8 | 36 | 82.8 |

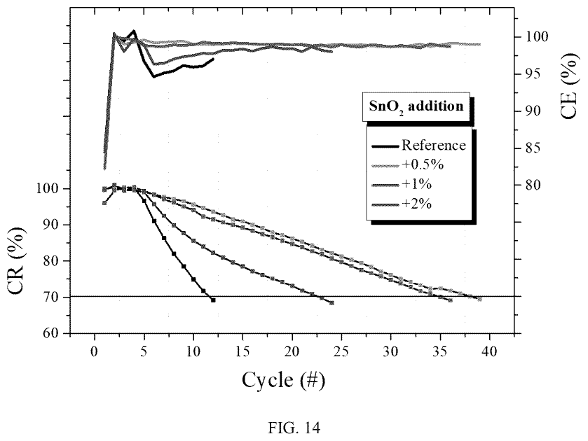

As shown in FIG. 14 and in Table 10 below, the addition of SnO₂ significantly increases the CE of the cells compared to the reference cell. Addition of 0.5% SnO₂ exhibited a CE of 99.1%, and addition of 1% and 2% SnO₂ exhibited CEs of 99.0% and 98.1%, respectively.

As further shown in FIG. 12, capacity retention (CR) is similarly enhanced: whereas the reference cell reaches 70% CR after 12 cycles, addition of 0.5% SnO₂ resulted in 70% CR after 39.

TABLE 10
cycle-life parameters of NCA/Cu cells with 0.5%,
1% or 2% SnO₂ particles or reference cell without SnO₂ (using
0.95M LiPF₆ + 0.05M LiBOB dissolved in EMC:DMC:FEC:PC
3:3:3:1 (v/v) as electrolyte)

| | CE (%) | 70% CR | CE (%) |
|---|---|---|---|
| SnO₂ Additive | cycle 2 - 70% CR | (cycle #) | 1st cycle |
| reference | 97.1 | 12 | 84.4 |
| 0.5% | 99.1 | 39 | 84.9 |
| 1% | 99.0 | 36 | 82.2 |
| 2% | 98.1 | 23 | 84.6 |

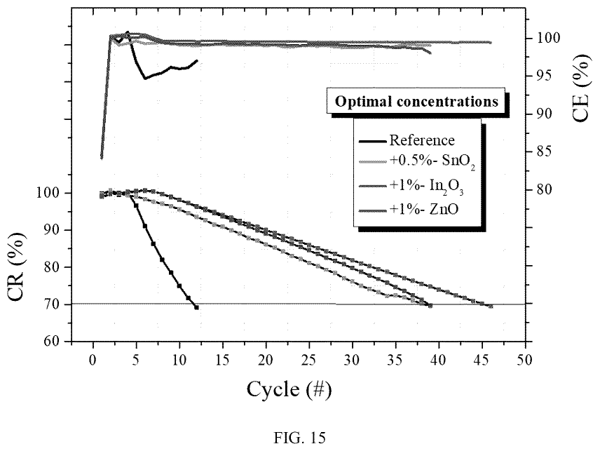

The performance of typical performing cells for the In₂O₃, ZnO, and SnO₂ nanoparticle additives is summarized in FIG. 15 and in Table 11.

As shown in FIG. 15 and Table 11, among all additives, In₂O₃ exhibited the most pronounced effect, with 1% addition as the optimal concentration, resulting in a CE of 99.6% and CR of 70% after 46 cycles.

TABLE 11
cycle-life parameters of NCA/Cu cells with In₂O₃,
ZnO, and SnO₂ nanoparticles or reference cell without nanoparticles
(using 0.95M LiPF₆ + 0.05M LiBOB dissolved in
EMC:DMC:FEC:PC 3:3:3:1 (v/v) as electrolyte)

| | CE (%) | 70% CR | CE (%) |
|---|---|---|---|
| Additive | cycle 2 - 70% CR | (cycle #) | 1st cycle |
| reference | 97.1 | 12 | 84.4 |
| 1% In₂O₃ | 99.6 | 46 | 84.6 |
| 1% ZnO | 99.2 | 39 | 84.1 |
| 0.5% SnO₂ | 99.1 | 39 | 84.9 |

Without being bound by any particular theory, it is believed that the beneficial effects of 0.5% to 2% nano-ceramic particles in the electrolytes are associated with their beneficial effects on the properties of the SEI (thickness, composition, and morphology) and on the morphology of the lithium deposition.

The effect of high pulse current at the beginning of the lithium deposition was studied. The current was varied from 3 mA/cm² to 30 mA/cm², and the pulses time were varied from 2 to 25 seconds. In this process a small amount of capacity, ranging from 0.05 mAh/cm² to 0.3 mAh/cm² was used. Later the deposition continued at smaller currents. It was found that this process causes the formation of high concentration of nano size lithium particles on the surface of the copper foil.

### NCA/Si Cells:

NCA/Si cells were assembled with an electrolyte consisting of 1 M LiPF₆ dissolved in EC:DEC 1:1 (v/v)+2% VC and 15% FEC, with or without addition of 1% and 2% TiO₂ nanoparticles.

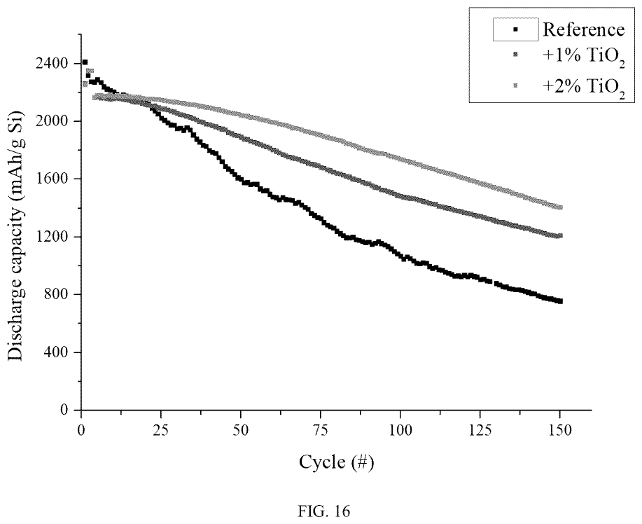

All the cells were cycled for 150 cycles. the coulombic efficiency (CE) was calculated as an average from cycle 4 until cycle 150. As shown in FIG. 16 and Table 12, the addition of TiO₂ increases the capacities and the CE of the cells compared to the reference cell. The reference cell showed CE of 99.19%, whereas the addition of 1% and 2% TiO₂ showed CE of 99.64% and 99.68, respectively. The reference cell showed 150th-cycle discharge capacity of 756 mAh/g Si, whereas the addition of 1% and 2% TiO₂ showed CE of 1211 mAh/g Si and 1404 mAh/g Si, respectively. The addition of 2% TiO₂ almost doubles the obtained capacity after 150 cycles.

TABLE 12
cycle-life parameters of NCA/Si cells with 1% or 2%
TiO₂ nanoparticles or reference cell without nanoparticles
(using 1M LiPF₆ dissolved in EC:DEC 1:1 (v/v) +
2% VC and 15% FEC (v/v) as electrolyte)

| | CE (%) | Discharge capacity at | CE (%) |
|---|---|---|---|
| Additive | cycle 4-150 | cycle 150 (mAh/g Si) | 1st cycle |
| reference | 99.19 | 756 | 64.1 |
| 1% TiO₂ | 99.64 | 1211 | 78.7 |
| 2% TiO₂ | 99.68 | 1404 | 78.1 |

### NMC/Graphite Cells:

NMC/graphite cells were assembled with an electrolyte consisting of 1 M LiPF₆ dissolved in EC:DEC 1:1 (v/v)+2% VC and 15% FEC, with or without addition of 1% Al₂O₃+1% CsAc.

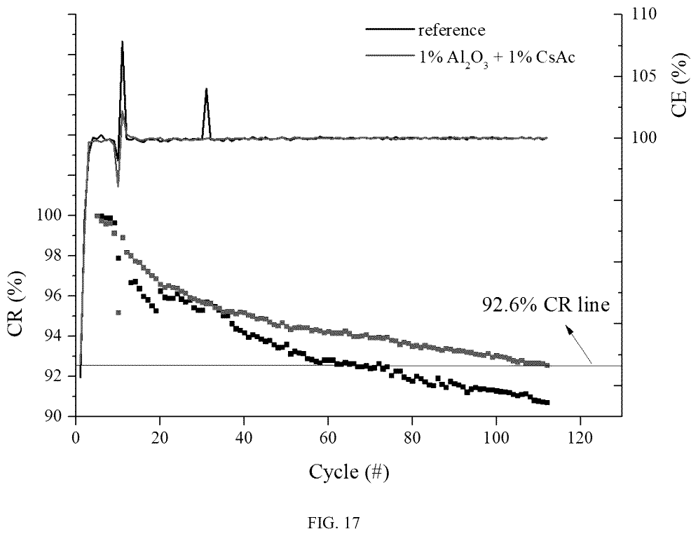

All the cells were cycled for 112 cycles. the coulombic efficiency (CE) was calculated as an average from cycle 5 until cycle 112. As shown in FIG. 17 and Table 13, the CR of the cell with the addition of 1% Al₂O₃+1% CsAc is twice higher than in the reference cell, with a value of 92.6% after 112 cycles compared to 62 cycles. There CE is not affected by the addition of the additives.

TABLE 13
cycle-life parameters of NMC/graphite cells with 1% Al₂O₃ +
1% CsAc or reference cell (using 1M LiPF₆ dissolved
in EC:DEC 1:1 (v/v) + 2% VC and 15% FEC (v/v) as electrolyte)

| | CE (%) | 92.6% CR | CE (%) |
|---|---|---|---|
| Additive | cycle 4-112 | (cycle #) | 1st cycle |
| reference | 99.98 | 62 | 80.69 |
| 1% Al₂O₃ + 1% | 99.98 | 112 | 81.79 |
| CsAc | | | |

### NCA/Li Cells:

NCA/Li cells were assembled with an electrolyte consisting of 0.95 M LiPF₆+0.05 M LiBOB dissolved in EMC:DMC:FEC:PC 3:3:3:1 (v/v), or with an electrolyte consisting of 1 M LiPF₆ dissolved in EC:DEC 1:1 (v/v)+2% VC and 15% FEC, with or without addition of 0.5%-4% (w/w) of ceramic nanoparticles.

Compared to the anode-free configuration, the use of lithium metal as an anode increases the cyclability of the cell. The addition of the ceramic nanoparticles were found to further improve the durability of the cell, resulting in less capacity loss per cycle (compared to a reference cell, consisting an electrolyte without the ceramic nanoparticles).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. An electrochemical cell comprising:
an anode which comprises an alkali metal and/or a conductive solid suitable for deposition of said alkali metal thereupon;
a cathode comprising a substance capable of reversibly absorbing and releasing ions of said alkali metal; and
a liquid electrolyte comprising at least one additive selected from the group consisting of a ceramic nanoparticle dispersed in said liquid electrolyte and a polymer dissolved and/or dispersed in said liquid electrolyte.

2. The electrochemical cell of claim 1, wherein a concentration of said ceramic nanoparticles in said liquid electrolyte is in a range of from 0.5 to 10 weight percent.

3. The electrochemical cell of claim 1, wherein said ceramic nanoparticles comprise a compound characterized by being compatible with non-aqueous solvent and with said cathode, and selected from the group consisting of Al₂O₃, TiO₂, SiO₂, CeO₂, ZrO₂, Ag₂O, AgO, CuO, NiO, ZnO, ZnCO₃, SiC, SnO₂, In₂O₃, Fe₂O₃ and Ga₂O₃.

4. The electrochemical cell of claim 1, wherein said ceramic nanoparticles comprise a metal fluoride solid characterized by being compatible with non-aqueous solvent and with said cathode, and wherein a metal in said metal fluoride solid is selected from the group consisting of Li, Na, K, Rb, Be, Mg, Ca, Sr, Ba, Ti, Zr, V, Cr, Mo, W, Mn, Fe, Co, Ni, Cu, Ag, Zn, Cd, Al, Ga, In, Tl, Si, Ge, As, Sb, and Bi.

5. The electrochemical cell of claim 1, wherein said ceramic nanoparticles comprise a compound characterized by being compatible with a non-aqueous solvent and with said cathode, selected from the group consisting of a metal oxide, a metal carbide, a metal phosphide, a metal nitride, a metal sulfide, and wherein a metal in said metal oxide, said metal carbide, said metal phosphide, said metal nitride, and said metal sulfide is individually selected from the group consisting of Be, Ca, Sr, Ba, Ti, Zr, V, Cr, Mo, W, Mn, Fe, Co, Ni, Cu, Ag, Zn, Cd, Al, Ga, In, Tl, Ge, As, Sb, Bi and Si.

6. The electrochemical cell of claim 1, wherein said conductive solid comprises a substance selected from the group consisting of silicon, a silicon alloy, carbon, graphite, nickel, copper, and a stainless foil.

7. The electrochemical cell of claim 1, wherein a concentration of said polymer in said liquid electrolyte is in a range of from 0.1 to 20 weight percent.

8. The electrochemical cell of claim 1, wherein said polymer is selected from the group consisting of polyacrylonitrile, polyvinyl pyrrolidone, polymethyl methacrylate, polyvinylidene difluoride, and polyethylene oxide.

9. (canceled)

10. The electrochemical cell of claim 1, further comprising a solid electrolyte and/or separator.

11. The electrochemical cell of claim 10, wherein said liquid electrolyte is in a form of a thin film between said solid electrolyte and said anode and/or between said solid electrolyte and said cathode.

12. The electrochemical cell of claim 11, wherein said liquid electrolyte is in a form of a thin film between said solid electrolyte and said anode and a concentration of said nanoparticles in said liquid electrolyte is in a range of from 0.1 to 5 weight percent.

13-14. (canceled)

15. The electrochemical cell of claim 1, wherein said liquid electrolyte comprises at least one organic solvent.

16. The electrochemical cell of claim 15, wherein said organic solvent is selected from the group consisting of a carbonate ester and an ether.

17-18. (canceled)

19. The electrochemical cell of claim 1, wherein said liquid electrolyte comprises at least one alkali metal salt.

20. The electrochemical cell of claim 19, wherein said alkali metal salt comprises a counter-ion selected from the group consisting of hexafluorophosphate, trifluoromethanesulfonate, bis(trifluoromethane)sulfonimide, tetrafluoroborate, bis(oxalato)borate, and difluoro(oxalato)borate.

21. (canceled)

22. The electrochemical cell of claim 1, wherein a pressure within the cell is in a range of from 1 to 20 atmospheres.

23. The electrochemical cell of claim 22, wherein said pressure is in a range of from 2 to 5 atmospheres.

24. The electrochemical cell of claim 1, wherein said alkali metal is selected from the group consisting of lithium, sodium and potassium.

25. (canceled)

26. A process of preparing the electrochemical cell of claim 1, the process comprising contacting said liquid electrolyte with said cathode and/or said conductive solid, wherein said conductive solid is substantially devoid of said alkali metal, to thereby obtain said electrochemical cell in a discharged state wherein said cathode is in an alkalated form.

27. The process of claim 26, further comprising contacting said liquid electrolyte with a solid electrolyte.

28. The process of claim 26, further comprising applying an electric potential between said conductive solid and said cathode such that said alkali metal deposits on said conductive solid, to thereby obtain said electrochemical cell in a charged state.

29. A process of preparing the electrochemical cell of claim 1, the process comprising contacting said liquid electrolyte with said cathode and/or said conductive solid, wherein said conductive solid is coated with a layer of said alkali metal.

30. The process of claim 29, further comprising contacting said liquid electrolyte with a solid electrolyte.

31. The process of claim 29, wherein an average thickness of said layer of said alkali metal is in a range of from 0.1 to 20 μm.

32. A rechargeable alkali metal ion battery comprising at least one electrochemical cell according to claim 1.
